(19) United States
(12) Patent Application Publication
(10) Pub. No.: US 2001/0020292 A1
(43) Pub. Date: Sep. 6, 2001

(54) Apparatus and method for emulating terminal attributes using a web server

(75) Inventor: Graeme Denis McRobert, Wiltshire, GB (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machine Corporation, Armonk, NY (US)

(21) Appl. No.: 09/794,300

(22) Filed: Feb. 27, 2001

(30) Foreign Application Priority Data
Mar. 3, 2000 (GB) 0005036.9

(51) Int. Cl. G06F 9/44

(52) U.S. Cl. 717/1

(57) ABSTRACT

A method, computer program product and apparatus for controlling an attribute of a data element used by an input/output device of which a display space is controlled by a markup language. The method comprises steps of: defining a unique identifier; associating the unique identifier with a statically-defined attribute; providing the unique identifier to allow an application program to create a runtime definition of the attribute in memory; checking for the existence of the runtime definition in the memory; and if the runtime definition is in the memory, refraining from acting upon the statically-defined attribute associated with the unique identifier in favor of acting upon the runtime definition. This permits a terminal template-based application to dynamically control attributes in a page defined with a markup language such as HTML.

### TECHNICAL FIELD

The present invention relates generally to an improved data processing system and in particular to a method and apparatus for emulating the capability of an application to modify a terminal display's field attributes.

### BACKGROUND OF THE INVENTION

In data processing using conventional host and terminal communications, the control of the content and appearance of the terminal display has traditionally been carried out by the application program, sometimes with the assistance of screen painting or templating control functions supplied by middleware programs.

One such environment is one in which IBM's CICS transaction processing family of products has been used in conjunction with user application programs to process very high-volume business data processing functions, typically against very large databases.

CICS was the earliest online transaction processing software product, and in its conventional versions, ran as a host-and-terminal processing environment, as compared with the more modem client-server applications developed for operation on personal computers and network servers.

Because such host-and-terminal environments are still heavily used, and are well suited to large volume transaction processing, there is considerable interest in continuing to use parts of these environments, while adapting the applications to cooperate with more modem client-server and three-tier architectures.

A difficulty that has been frequently noted is that the older architectures and the newer architectures embody different communication and programming paradigms. One example of the way in which this difference is important is in the area of web-enablement: the integration of conventional systems into World Wide Web electronic commerce environments.

On a conventional terminal display, the displayable data can be divided into static and dynamic data. Static data can be predefined in a template. An example of this use is the Basic Mapping Support function (BMS) in IBM's CICS family of transaction processing products, which allows the static data components of screens to be designed offline so that the application need only fill in any dynamic fields at run time.

This model can be extended to browsers by defining static HTML pages with embedded Server Side Include (SSI) commands. SSI commands are commands that instruct a server side software program to modify certain elements of an HTML page based on variable data while building a page to be served to a client's browser program. Examples of SSI commands are #SET and #ECHO. #SET permits a variable to be identified and set to a value, and #ECHO permits such a value to be placed in an HTML page. Applications can set SSI variables and they are substituted by software in the server at run time before it serves the page to the client's browser. This mechanism is currently implemented in the CICS Web Interface BMS emulation.

This implementation however only applies to the data that is displayed on the screen and not to the attributes governing how the data is displayed. This means that the data's attributes cannot be changed dynamically at run time; so, for example, a programmer cannot dynamically change a field to be underlined or change the field from an output field to an input field, and so on.

The disparity in the paradigms involved leads to considerable difficulty and expenditure of skilled programmer time in emulating the capabilities of the conventional applications in the new web-based environments. The only options conventionally available to the programmer are to cause the application either to generate all the HTML dynamically or to generate the HTML from static pages and alter it once the page is loaded into a buffer. In the first case, the advantages of using the templating capabilities of BMS are sacrificed. In the second case the application needs to locate the HTML for the element being modified in the buffer and then remove the old attributes and add the new attributes. This can involve shifting the contents of the buffer which is potentially expensive in processing costs.

### SUMMARY OF THE INVENTION

The present invention accordingly provides, in a first aspect, a method for controlling a statically-defined attribute of a data element used by an input/output device of which a display space is controlled by a markup language, the method comprising the steps of: defining a unique identifier for an attribute descriptor; associating the unique identifier with the statically-defined attribute; providing the unique identifier to an application program to allow creation of a runtime definition of the attribute in a memory; checking for existence of the runtime definition in the memory; and responsive to an indication of existence of the runtime definition in the memory, refraining from acting upon the statically-defined attribute associated with the unique identifier in favour of acting upon the runtime definition.

The method of the first aspect is preferably further characterised in that said markup language comprises HTML.

The method of the first aspect is preferably further characterised in that said markup language comprises XML.

The method of the first aspect preferably further comprises processing a terminal display template.

The method of the first aspect is preferably further characterised in that said statically-defined attribute is defined using a Server Side Include command.

In a second aspect, the present invention provides a server side computer program product, tangibly embodied on a computer-readable medium, comprising computer program code to, when loaded and executed on a computer system, cause the computer system to perform the steps of the method of the first aspect.

In a third aspect, the present invention provides apparatus for controlling a statically-defined attribute of a data element used by an input/output device of which a display space is controlled by a markup language, the apparatus comprising: a generator component for generating a unique identifier for an attribute descriptor; an attribute controller component for associating the unique identifier with the statically-defined attribute; a definition component to allow creation of a runtime definition of the attribute in the memory; an existence checker component to check for existence of the runtime definition in the memory; and a runtime control component responsive to receipt of positive result from the existence checker component, for refraining from acting upon the statically-defined attribute associated with the unique identifier in favour of acting upon the run time definition.

The apparatus of the third aspect is preferably further characterized in that said markup language comprises HTML.

The apparatus of the third aspect is preferably further characterized in that said markup language comprises XML.

The apparatus of the third aspect preferably further comprises a terminal-display template-processing component.

The apparatus of the third aspect is preferably further characterized in that said statically-defined attribute is defined using a Server Side Include command.

Thus advantageously, the server application does not need to know the location of the field in the HTML and there is no direct modification of the data in the HTML buffer which is going to be served to the browser. Such modifications are typically costly in processing time and slow down the response of the system to user requests. The developer advantageously enjoys the freedom of customizing the HTML offline using static HTML pages instead of having to write an application to generate the HTML dynamically. Such applications are typically time-consuming to create and maintain and costly in skilled programmer time.

### BRIEF DESCRIPTION OF THE DRAWINGS

A preferred embodiment of the present invention will now be described by way of example, with reference to the accompanying drawings in which:

FIG. 1 is a diagram of a client/server system in accordance with a preferred embodiment of the present invention;

FIG. 2 is a flowchart showing the steps of a method according to a preferred embodiment of the present invention.

### DETAILED DESCRIPTION OF THE PREFERRED EMBODIMENT

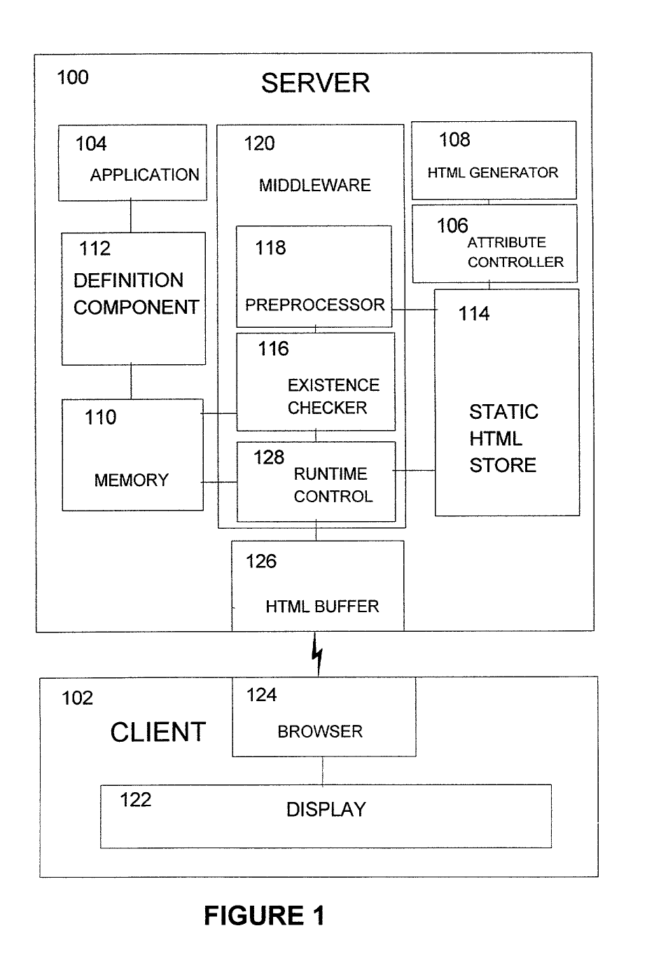

With reference now to the figures and in particular with reference to FIG. 1, depicted are a client (102) and a server (100). Client (102) has a browser (124) and a display (122) for displaying Internet web content that has been delivered via a network. Internet web content is conventionally delivered in the form of HTML (HyperText Markup Language) pages.

Server (100) has a memory (110), a static HTML store (114), and an HTML buffer (126). HTML generator (108) is capable of generating static HTML pages for storage in the static HTML store. Attribute controller (106) controls attributes in the static HTML by the use of #SET and #ECHO Server Side Include commands. Application (104) invokes a definition component (112) to define attribute variables and stores them in memory (110). Middleware (120) provides a runtime environment for the generation of web pages on behalf of application (104). Middleware (120) includes preprocessor (118), existence checker (116), and runtime control (128). Preprocessor (118) retrieves the previously-generated HTML from static HTML store (114) and begins to process it. On finding #SET commands within the HTML page, preprocessor (116) invokes existence checker (116) to determine if there are in memory (110) any attribute definition variables of the same name as those for which there are #SET commands in the HTML. If there are any such variables, runtime control (128) prevents preprocessor (118) from obeying the corresponding Server Side Include #SET command, thereby causing the HTML to be assembled in the HTML buffer (126) using the attribute definition variable found in memory (110). The server (100) serves the HTML page content from the HTML buffer to the browser (124) in the client (102), where it is displayed on the display according to the attribute definition variable that was found in memory (110).

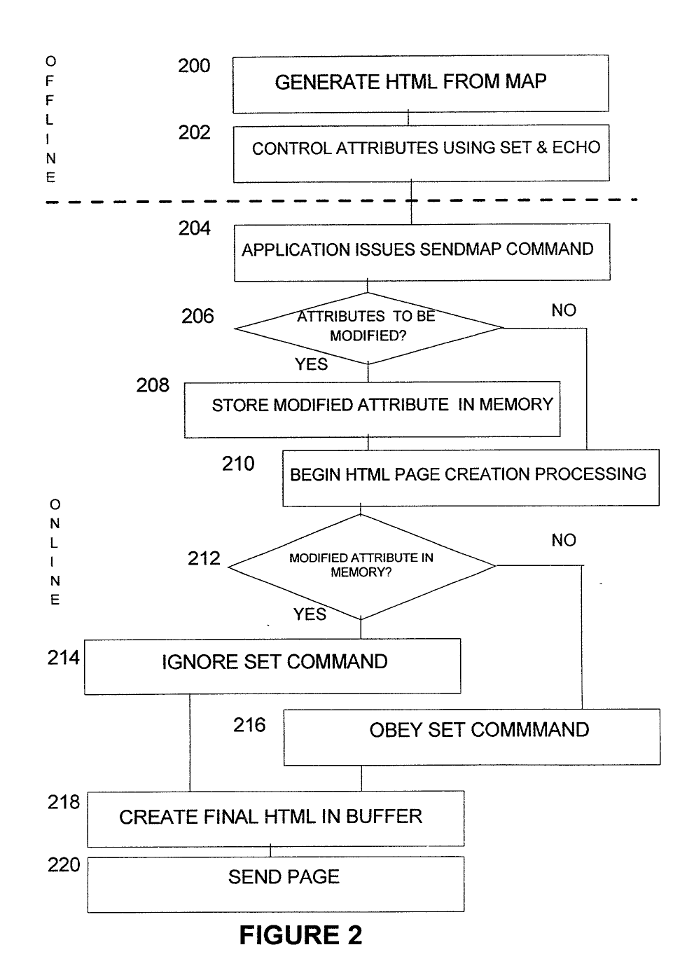

Referring now to FIG. 2, the process steps of a method according to a preferred embodiment begin with step (200) in which the HTML is generated offline from a BMS map definition. In step (202) the attributes in the static HTML definition are controlled by the use of #SET and #ECHO commands placed in the HTML source. These first steps (200) and (202) are performed offline, prior to run time. The remainder of the steps (204) to (220) are performed online (at run time). In step (204), the application issues a BMS SENDMAP command. If the application (104) determines by means of a test in step (206) that any attributes are to be modified, it causes the attribute definition variables to be stored in memory (110) in step (208). Whether or not there are any such attributes needing modification, the next step (210) is to begin processing to create the HTML page to be served. If any Server Side Include #SET commands are found, then on behalf of the application a test is performed in step (212) to determine if there are any modified attribute definition variables in memory. If so, step (214) is to cause the corresponding #SET command or commands to be ignored. If there are no such modified attribute variables in memory, then in step (216), any Server Side Include #SET commands are obeyed. In either case, in step (218) the final HTML page is created in the buffer, and the page is sent in step (220).

The following material serves as a worked example of a possible use of an embodiment of the present invention, with some explanation of the specific mechanisms of BMS maps and HTML. It will be clear to one skilled in the art that there may be other embodiments involving the adaptation of attribute-handling techniques from the terminal template model of the conventional host-and-terminal environment and any markup language environment. The terminal template model is one that has wide acceptance in the world of data processing, and the markup language model is one that is gaining increasing acceptance in the distributed, web-enabled electronic commerce environment. One example of a markup language other than HTML that is in widespread use in this environment is the Extensible Markup Language (XML).

In HTML a data element can be broken into 3 parts. There is a prefix attribute, the displayable data itself and a suffix attribute. For example, to underline a field with a value of “This field is underlined” the following HTML would be used:

<u>This field is underlined</u>

in which the <u> tag is the prefix attribute, the string “This field is underlined” is the displayable data and the </u> tag is the suffix attribute. If the field has no attributes, the prefix and suffix attributes can be considered to be nulls.

Input fields are more complex. For a 10 byte input field called InField1, the HTML could be:

<input type=text name=InField1 value=“A Value” size=10 maxlength=10>

This HTML string can be broken into 3 parts as well. The attribute parts specify that the field is an input field and define its size and name. The prefix attribute is therefore the string “<input type=text name=InField1 value=” “and the suffix attribute is ” “size=10 maxlength=10>” and the displayable data is the string “A Value”.

On a display terminal, the display surface is divided up into a matrix of fixed sized cells so the starting position of a field can be determined by its row and column position. Using the row and column position a programmable method can be used to generate names which would be the same with each execution of the algorithm using the same row and column position. Using this mechanism, three names for each field we wish to display can be generated. An example would be RxCyPrefix, RxCyData and RxCySuffix, where x and y are the row and column numbers respectively.

The Server Side Include command set implements a command #SET to set an environment variable which can later be substituted in the HTML using a Server Side Include #ECHO command. The application, by contrast, is capable of setting the environment variable in memory. The value supplied by the application then takes precedence over any corresponding #SET command. This means that if an environment variable with the same name as that specified on the #SET command already exists in memory, then the #SET command is to be ignored.

Using Server Side Include commands, the three fields could be set to default values. Taking the first example, the following HTML would be used:

<!—#set var=RxCyPrefix value=“<u>”—>

<!—#set var=RxCyData value=“This field is underlined”—>

<!—#set var=RxCySuffix value=“</u>”—>

<!—#echo var=RxCyPrefix—><!—#echo var=RxCyData—><!—#echo var=RxCySuffix—>

If this HTML was sent to a browser through an SSI enabled server, the browser would receive the output:

<u>This field is underlined</u>

If the application decided to change the attributes on this field to bright and underline, the application could set the variable RxCyPrefix to “<strong><u>” and the variable RxCySuffix to “</u></strong>” and the resulting HTML string which the browser would receive would be:

<strong><u>This field is underlined</u></strong>

To change the field to an input field 25 bytes long, the application could set variable RxCyPrefix to “<input type=text name=RxCyData value=” “and the variable RxCySuffix to ” “size=25 maxlength=25>” and the resulting HTML which would be sent to the browser would be:

<input type=text name=RxCyData value=“This field is underlined” size=25 maxlength=25>

The end-user would then see the sentence: “This field is underlined”, and would be able to enter input by over typing the field.

The present invention is preferably embodied as a computer program product for use with a computer system. Such an implementation may comprise a series of computer readable instructions either fixed on a tangible medium, such as a computer readable media, e.g., diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

What is claimed:

1. A method for controlling a statically-defined attribute of a data element used by an input/output device of which a display space is controlled by a markup language, the method comprising the steps of:
defining a unique identifier for an attribute descriptor;
associating the unique identifier with the statically-defined attribute;
providing the unique identifier to an application program to allow creation of a runtime definition of the attribute in a memory;
checking for existence of the runtime definition in the memory; and
responsive to an indication of existence of the runtime definition in the memory, refraining from acting upon the statically-defined attribute associated with the unique identifier in favor of acting upon the runtime definition.

2. A method as claimed in claim 1, further characterized in that said markup language comprises HTML.

3. A method as claimed in claim 1, further characterized in that said markup language comprises XML.

4. A method as claimed in claim 1, further comprising processing a terminal display template.

5. A method as claimed in claim 1, further characterized in that said statically-defined attribute is defined using a Server Side Include command.

6. A server side computer program product, tangibly embodied on a computer-readable medium, comprising computer program code to, when loaded and executed on a computer system, cause the computer system to perform the steps of a method as claimed in claim 1.

7. Apparatus for controlling a statically-defined attribute of a data element used by an input/output device of which a display space is controlled by a markup language, the apparatus comprising:
a generator component for generating a unique identifier for an attribute descriptor;
an attribute controller component for associating the unique identifier with the statically-defined attribute;
a definition component to allow creation of a runtime definition of the attribute in the memory;
an existence checker component to check for existence of the runtime definition in the memory; and
a runtime control component responsive to receipt of positive result from the existence checker component, for refraining from acting upon the statically-defined attribute associated with the unique identifier in favor of acting upon the run time definition.

8. Apparatus as claimed in claim 7, further characterized in that said markup language comprises HTML.

9. Apparatus as claimed in claim 7, further characterized in that said markup language comprises XML.

10. Apparatus as claimed in claim 7, further comprising a terminal-display template-processing component.

11. Apparatus as claimed in claim 7, further characterized in that said statically-defined attribute is defined using a Server Side Include command.
